(19) United States
(12) Patent Application Publication
(10) Pub. No.: US 2026/0266985 A1
(43) Pub. Date: Sep. 10, 2026

(54) SYSTEM AND METHOD OF SCANNING ITEMS WITHIN ENCLOSURE USING SYNTHETIC APERTURE RADAR ON A HUMANOID ROBOT

(71) Applicant: WAVEYE, INC., Palo Alto, CA (US)

(72) Inventors: Gor Hakobyan, SCHOENAICH (DE); Levon Budagyan, Palo Alto, CA (US); Narek Rostomyan, San Diego, CA (US)

(73) Assignee: WAVEYE, INC., Palo Alto, CA (US)

(21) Appl. No.: 19/666,416

(22) Filed: May 4, 2026

Related U.S. Application Data
(63) Continuation of application No. PCT/US24/54307, filed on Nov. 2, 2024.

(51) Int. Cl. G01S 13/90; B25J 11/00; B65G 1/137

(52) U.S. Cl. CPC G01S 13/9021; B25J 11/00; B65G 1/137

(57) ABSTRACT

A method and system for inferring characteristics of one or more objects using a humanoid robotic system equipped with a radar sensor by generating a trajectory, moving manipulating arms of the humanoid robotic system according to the generated trajectory, generating, a synthetic radar aperture from the movement of the manipulating arms, generating, by the radar sensor, a synthetic aperture radar image; and inferring the characteristics of the one or more objects from the synthetic aperture radar image.

### BENEFIT CLAIM

This application claims the benefit under 35 U.S.C. 120 and 35 U.S.C 365(c) of a prior international application designating the U.S., PCT/US24/54307, filed Nov. 2, 2024, the entire contents of which are hereby incorporated by reference for all purposes as if fully set forth herein.

### FIELD OF THE TECHNOLOGY

The present invention relates to the field of robotics technology, in particular to scanning items within enclosure using synthetic aperture radar on a humanoid robot.

### BACKGROUND

The delivery of goods to customers has been an important aspect of modern society. With the explosion of various e-commerce platforms, many companies may sort, store, package, and ship items and/or groups of items from distribution facilities. In distribution facilities, various material handling systems and processes frequently require substantial operational time, leading to high logistical costs.

In a distribution facility, a material handling process might involve a sorting system (e.g., conveyor-based sorting system or robotic arm based sorting system) identifying an appropriate storage position on shelves for items stored in a non-transparent container. Thus, the sorting system may need to open the container, inspect and categorize the items and/or groups of items within the container and subsequently determine which storage rack/shelf corresponds to the category of items and/or groups of items within the container. Additionally, traditional sorting systems that operate on pre-defined instructions are unable to respond optimally to new scenarios in an autonomous manner. Consequently, the efficiency of these systems in distribution facilities is low, making it challenging to meet the warehousing system's time-varying production demands.

Accordingly, there is a need for a flexible and automated system and method to facilitate the various material handling processes within a distribution facility, thereby improving the speed and efficiency thereof.

### BRIEF DESCRIPTION OF THE DRAWINGS

Various exemplary embodiments of the present disclosure are described in detail below with reference to the FIGS. 1A, 1B, 2, 3A, 3B, 3C, and 4. The figures are provided for illustrative purposes only and merely depict exemplary embodiments of the present disclosure to aid the reader's understanding of the present disclosure. Therefore, the drawings should not be considered limiting of the breadth, scope, or applicability of the present disclosure. It should be noted that for clarity and ease of illustration these drawings are not necessarily drawn to scale.

FIG. 1A is a block diagram of a material handling process flow at a distribution facility utilizing humanoid robotic system equipped with a synthetic aperture radar, in accordance with some embodiments of the present disclosure.

FIG. 1B is a block diagram illustrating a material handling process flow within a material inspection facility that employs a humanoid robotic system equipped with a synthetic aperture radar, which is designed to inspect the contents of containers on a pallet or other transport platform and classify them accordingly, in accordance with certain embodiments of the present disclosure.

FIG. 2 is a block diagram and close-up view of the container scanning process shown in FIGS. 1A and 1B, using a humanoid robotic system equipped with synthetic aperture radar, in accordance with some embodiments of the present disclosure.

FIG. 3A is a schematic of a planar linear trajectory of a robotic arm used to generate a synthetic aperture radar image, in accordance with some embodiments of the present disclosure.

FIG. 3B is a schematic of a crossing trajectory of a robotic manipulating arm for generating a synthetic aperture radar image, in accordance with some embodiments of the present disclosure.

FIG. 3C is a schematic of a 3D trajectory of a robotic manipulating arm for generating a synthetic aperture radar image, in accordance with some embodiments of the present disclosure.

FIG. 3D is schematic of a circular trajectory of a robotic manipulating arm for generating a synthetic aperture radar image, in accordance with some embodiments of the present disclosure.

FIG. 4 is a flow diagram of a method for 3D synthetic aperture radar imaging using a trajectory of a robotic manipulating arm, in accordance with some embodiments of the present disclosure.

### DETAILED DESCRIPTION OF EXEMPLARY EMBODIMENTS

Various exemplary embodiments of the present disclosure are described below with reference to the accompanying figures to enable a person of ordinary skill in the art to make and use the present disclosure. As would be apparent to those of ordinary skill in the art, after reading the present disclosure, various changes or modifications to the examples described herein can be made without departing from the scope of the present disclosure. Thus, the present disclosure is not limited to the exemplary embodiments and applications described and illustrated herein. Additionally, the specific order and/or hierarchy of steps in the methods disclosed herein are merely exemplary approaches. Based upon design preferences, the specific order or hierarchy of steps of the disclosed methods or processes can be re-arranged while remaining within the scope of the present disclosure. Thus, those of ordinary skill in the art will understand that the methods and techniques disclosed herein present various steps or acts in a sample order, and the present disclosure is not limited to the specific order or hierarchy presented unless expressly stated otherwise.

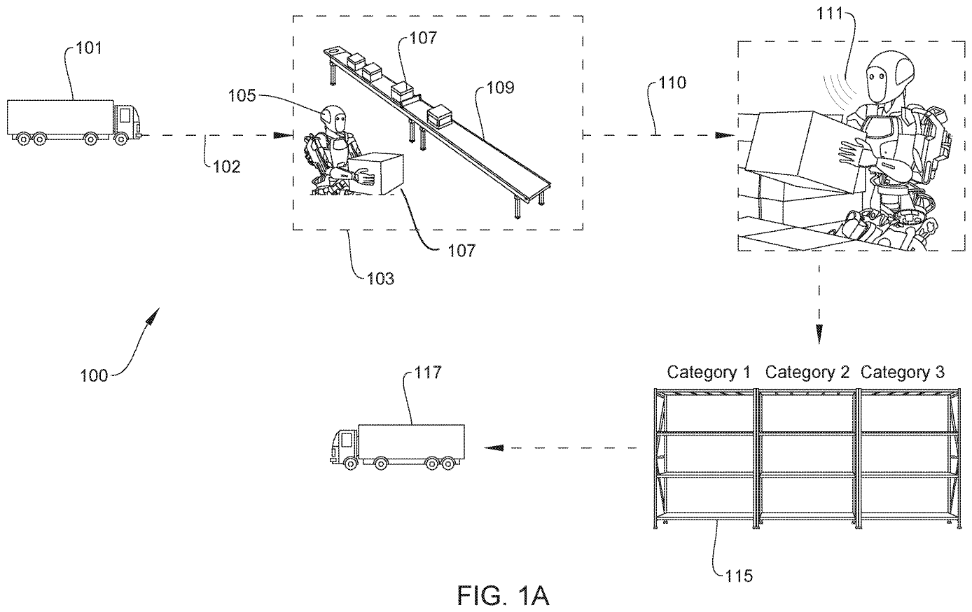

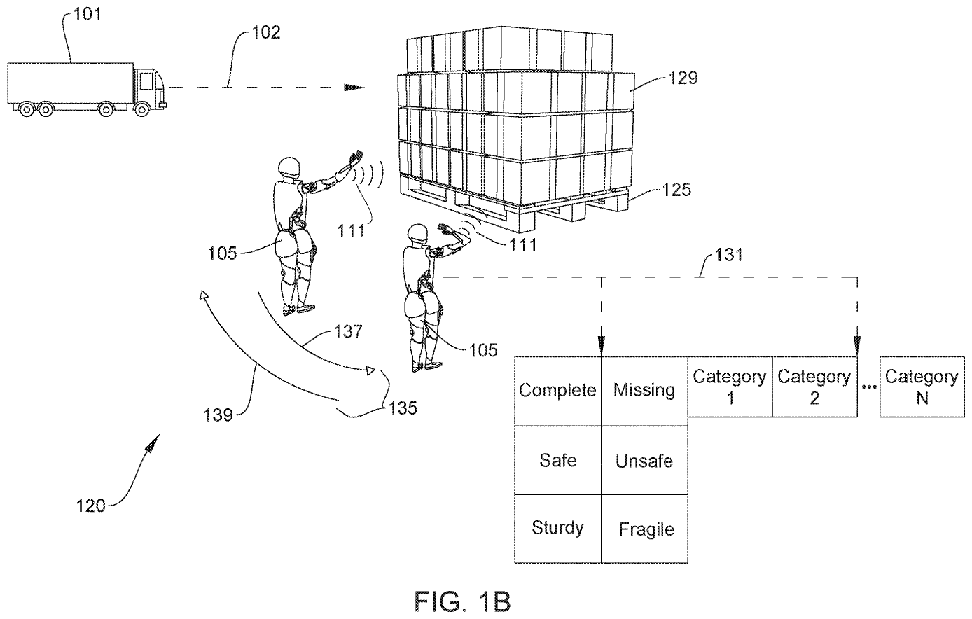

FIG. 1A illustrates an example of a material handling process flow at a distribution facility 100. As shown in FIG. 1A, a plurality of items may be delivered via a first shipping equipment 101, for example, a commercial truck or rail, to the distribution facility 100 for sorting, storing, packing, or shipping to destination locations (e.g., customers or other distribution facilities). In some embodiments, the commercial truck or rail may be autonomous. The plurality of items may be unloaded using manual, robotic, automated, or semi-automated processes or systems 102 and received at the conveyance area 103 for further processing. In one embodiment, the conveyance area 103 may include one or more conveying system(s) 109 and humanoid robotic system(s) 105 configured to grasp, lift, hold, move, and place moving containers 107 that enclose a plurality of items. In some embodiments, the walls of the containers 107 may be formed from sturdy, lightweight materials, such as plastics, cardboard, fiberboard, composites, metals, other materials, or combinations thereof. In some exemplary embodiment, the walls of the container 107 may block visible light and may obstruct optical camera-based sensors from imaging the content of a container 107.

In some embodiments, the humanoid robotic system(s) 105 may be a humanoid robot(s) having two arms capable of grasping, lifting, holding, moving, and placing objects similar to human arms. In one embodiment, the humanoid robot system(s) 105 may be stationary. In another embodiment, the humanoid robot system(s) 105 may have a bipedal locomotion or a higher number of legs (e.g., four-legged or six-legged hexabot). In alternative embodiments, the humanoid robot system(s) 105 may have wheeled or tracked basis of locomotion. In some embodiments, the humanoid robot system(s) 105 may be an autonomous mobile robot comprising one or more robotic arm(s) and a wheeled robotic chassis.

In some embodiments, the humanoid robot(s) 105 may include a plurality of optical cameras configured to sense the humanoid robotic system's 105 environment. In some embodiments, the humanoid robotic system(s) 105 may grasp and lift the container 107 from the conveying system 109 for an inspection 110 task of the container 107 contents. In some embodiments, the humanoid robotic system(s) 105 may include one or more radar sensor(s) 111 located at its front portion of the humanoid robotic system(s) 105 and configured to identify the object(s) within the container 107. In various embodiments, the radar sensor(s) 111 may be installed in the upper body section, e.g., forearm(s), and/or in the head of the humanoid robotic system(s) 105. In one embodiment of the present invention, the radar sensor(s) 111 may be installed on the right and/or left forearm of the humanoid robot system 105. In other embodiments, the radar sensor(s) 111 may be a synthetic aperture radar.

In some embodiments, the humanoid robotic system 105 may utilize the information about the content of the container 107, obtained from the radar sensor(s) 111, to determine the location or level on which the container 107 will be stowed in the inventory storage area 115. In one embodiment, the radar sensor(s) 111 may use the sensed attributes of the object(s) within the container 107 such as sizes or dimensions, the structural integrity (e.g., fragile, not fragile), the material composition or classification (e.g., hazardous, flammable, corrosive, toxic) to determine the location or level in the inventory storage area 115 on which the container 107 will be stowed. In an exemplary embodiment, machine learning-based classification can be used to match radar-detected features or attributes of objects within container 107 to the appropriate location or level in the inventory storage area 115 where container 107 should be stored. In some embodiments, a convolutional neural network-based autoencoder (AE) is used to extract radar-detected features or attributes of objects within container 107.

In some embodiments, the inventory storage area 115 can include columns that are each arranged to hold containers in a same respective category (e.g., category 1, category 2, or category 3). For example, the humanoid robotic system(s) 105 may place all containers containing fragile object(s) into a column corresponding to the category 1, as shown in FIG. 1A. In other embodiments, a second shipping equipment 117 such as a (automated) commercial truck or rail vehicle designed to transport objects of a specific category (e.g., category 1, category 2, or category 3), may be utilized to deliver containers to final customers or other distribution facilities.

FIG. 1B illustrates an exemplary material handling process within a material inspection facility 120 that utilizes a humanoid robotic system(s) 105 equipped with one or more radar sensor(s) 111 to examine and categorize the contents of containers on a transport platform 125. In one embodiment, a shipping equipment 101, such as an automated commercial truck or rail may deliver a plurality of items stacked on a transport platform 125 at the inspection facility 120 for inspection and sorting. In some embodiments, the transport platform 125 may be unloaded from the shipping equipment 101 through manual, robotic, automated, and/or semi-automated systems 102. In one exemplary embodiment, the transport platform 125 stacks, in a grid pattern, containers 129 that enclose the plurality of items. In some embodiments, the walls of the containers 129 may be constructed from durable, lightweight materials like plastics, cardboard, fiberboard, composites, metals, or a combination of these. The walls of containers 129 may block visible light and may obstruct optical camera-based sensors from imaging the content of containers 129 stacked on the transport platform 125.

In various embodiments, the inspection facility 120 may include a humanoid robotic system(s) 105 configured to scan through the containers 129 using the radar sensor(s) 111. In some embodiments, the humanoid robotic system(s) 105 may traverse a trajectory 135 to synthesize a radar aperture. In some embodiments, the trajectory 135 may be a time-stamped geometric path describing a sequence of time-stamped coordinates that the humanoid robotic system(s) 105 occupies.

In some embodiments, the humanoid robotic system(s) 105 may track the trajectory 135 by generating control actions for its joints based on the trajectory 135. In one exemplary embodiment, the humanoid robotic system(s) 105, equipped with radar sensor(s) 111 in its forearm, can generate a synthetic radar aperture as its forearm follows the trajectory 135, thereby scanning its surroundings with high resolution.

In various embodiments, the trajectory 135 is autonomously generated by the humanoid robotic system(s) 105, taking into account factors such as synthetic aperture radar imaging time and the resulting radar image ambiguities. For example, the material handling processes in distribution facilities may necessitate low levels of radar image ambiguities, which could result in the humanoid robotic system(s) 105 generating a trajectory that requires a longer scanning time. In some embodiments, the radar sensor(s) 111 installed in the forearm can move up to half a meter allowing for a high imaging resolution (e.g., 1°) in either the azimuth or elevation dimensions, depending on the forearm's traversed trajectory 135. One exemplary advantage of the present invention is the accurate sensing of the humanoid robotic system(s) 105 surroundings through high-resolution synthetic aperture radar imaging, which is achieved by the physical movement of the radar sensor(s) 111 installed in its forearm, for example.

In one embodiment, the trajectory 135 may include a left to right trajectory portion 137 and a right to left trajectory portion 139. In some embodiments, the trajectory 135 may be a pre-programmed geometric path. In other embodiments, the trajectory 135 may be dynamically generated, enabling the humanoid robotic system(s) 105 to adjust from a pre-programmed geometric path to meet safety requirements (e.g., maintaining minimum separation distances from nearby objects and other humanoid robotic system(s)). In other embodiments, the trajectory 135 may be determined by the dimensions or spatial configuration of container 107 and the expected types of objects within container 107. Additionally, the humanoid robotic system(s) 105 may autonomously generate the trajectory 135 based on the allocated scanning time, as well as the position and orientation of the next container to be scanned. In some embodiments, the humanoid robotic system(s) 105 can determine the dimensions or spatial configuration of container 107 using its optical cameras. In certain embodiments, onboard optical cameras of the humanoid robotic system(s) 105 may be utilized for navigation within the distribution facility and the humanoid robotic system(s) 105 may activate radar sensor(s) 111 once the cameras identify container 107 for synthetic aperture radar imaging.

In some embodiments, the radar sensor(s) 111 in the humanoid robotic system(s) 105 captures a high-resolution synthetic aperture radar image of the items(s) inside the containers 129. In other embodiments, the radar sensor(s) 111 may be high-frequency millimeter-wave sensors operating at 60 GHz or higher.

In some embodiments, the humanoid robotic system(s) 105 includes a classification unit 131 that classifies the captured high-resolution synthetic aperture radar image to determine whether the containers 129 hold any objects that are unsafe/safe, complete/missing, or sturdy/fragile. In some embodiments, the classification unit 131 classifies objects within the containers 129 based on raw radar image data using a convolutional neural network (CNN). Moreover, Doppler signatures that highlight the unique features of each object within containers 129 can be utilized in deep learning neural networks.

One exemplary advantage of this invention is that it allows for the contents of the containers 129 to be identified without relying on optical sensing methods that require the containers to be opened and without the need to grasp the containers 129. In some embodiments, the humanoid robotic system(s) 105, based on the classified high-resolution synthetic aperture radar image, may transport the containers 129 to specific locations depending on the content and the category of the items within the containers 129.

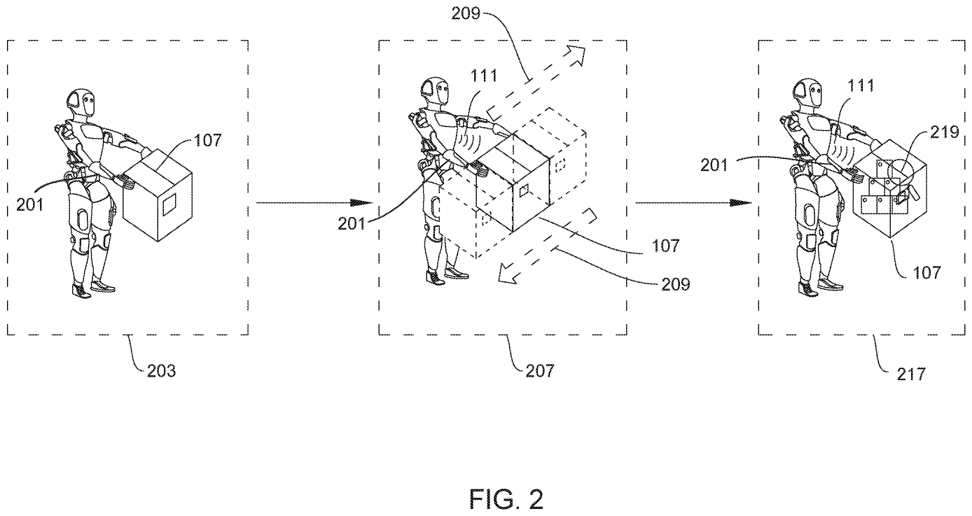

FIG. 2 is the detailed view of the container 107 scanning process depicted in FIGS. 1A and 1B, utilizing the synthetic aperture radar sensor(s) 111 installed on the torso portion of the humanoid robotic system(s) 105. The scanning process for the container 107 begins with the grasp and grip step 203, where the humanoid robotic system 105 uses the end-effectors of its manipulating arms 201 to close around the container 107. Additionally, the manipulating arms 201 maintain a firm hold on the container 107 after it has been grasped, ensuring a stable and secure grip. During the synthetic radar aperture generation step 207, the manipulating arms 201 move the container 107 along a trajectory 209 in front of the radar sensor(s) 111 to synthesize a radar aperture. In some embodiments, the trajectory 209 is a geometric path describing the motion of the manipulating arms 201. In various embodiments, the trajectory 209 may be pre-programmed. In other embodiments, the trajectory 209 may be dynamically generated allowing the manipulating arms 201 to deviate from a pre-programmed geometric path in order to satisfy safety constrains (e.g., minimum separation distance constraints from surrounding objects). During the identification step 217, a high resolution synthetic aperture radar image 219 of item(s) within the container 107 may be obtained using the information encoded in the trajectory 209. In some embodiments, the optical cameras on the humanoid robotic system(s) 105 may be used to adjust the position and orientation of the humanoid robotic system(s) 105 to optimize the generation of synthetic aperture radar image of container 107. For example, the humanoid robotic system(s) 105 may autonomously reposition its body using optical cameras, along with the radar sensor(s) 111 and manipulating arms 201, to satisfy the SAR imaging requirements, including aspect angle, incidence angle, or polarization. In some embodiments, the radar sensor(s) 111 may be activated once the humanoid robotic system(s) 105 has completed repositioning its body with the help of optical cameras, in conjunction with the radar sensor(s) 111 and manipulating arms 201. One advantage of the present invention is that the contents of the container 107 can be identified without utilizing optical sensing modalities that require the container 107 to be opened.

To synthesize an aperture, a signal processing unit is aware of the trajectory 209 of the manipulating arms 201. In some embodiments, the signal processing unit may be within the radar sensor(s) 111. In one embodiment, the trajectory 209 may be determined and supplied to the signal processing unit by the sensors and actuators that accurately measure the movements of manipulating arms 201. In other embodiments, a pre-programmed trajectory 209 may be supplied to the signal processing unit, along with the trajectory tracking errors, to generate a high-resolution 3D image 219 of item(s) within the container 107. In some exemplary embodiments, the high-resolution 3D synthetic aperture radar image 219 can be obtained by the Backprojection, Keystone transform, or Omega-k methods configured to be applied to the trajectory 209.

In another embodiment, the trajectory 209 can be estimated from the radar sensor(s) data algorithmically. In one embodiment, the trajectory 209 can be estimated by an autofocus algorithm that analyzes the radar return signals. In one exemplary embodiment, the radar sensor(s) 111 may have multiple radar channels and may be capable of array processing and configured to estimate the trajectory 209 by analyzing the relationships between angle estimates and their Doppler shifts.

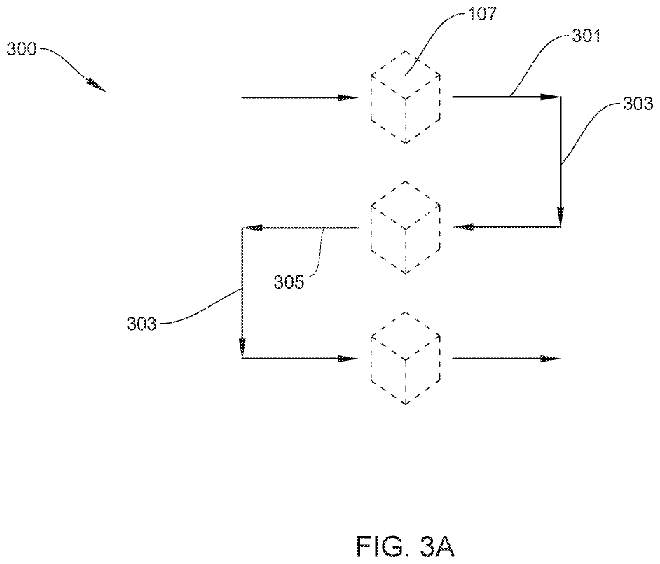

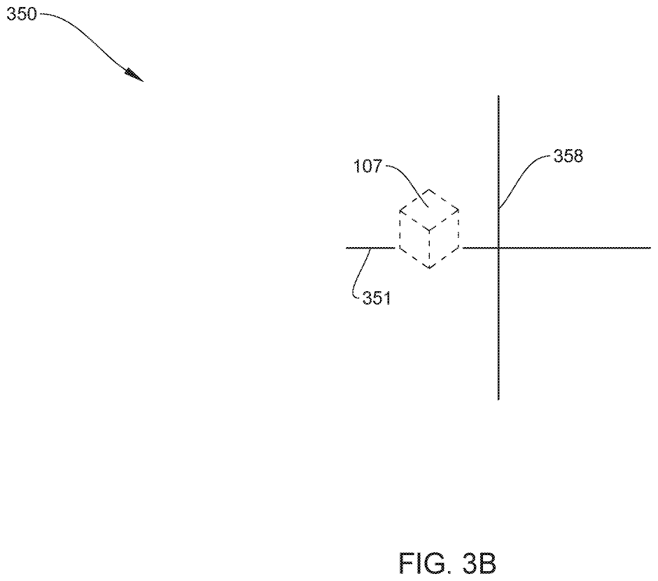

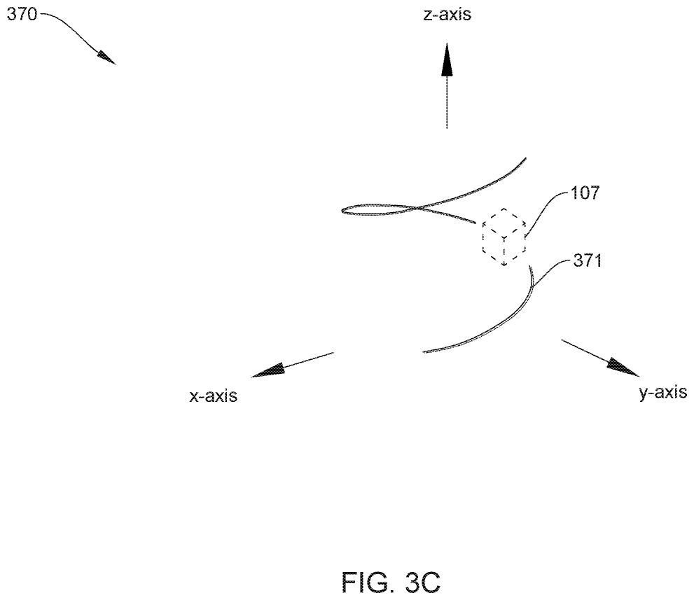

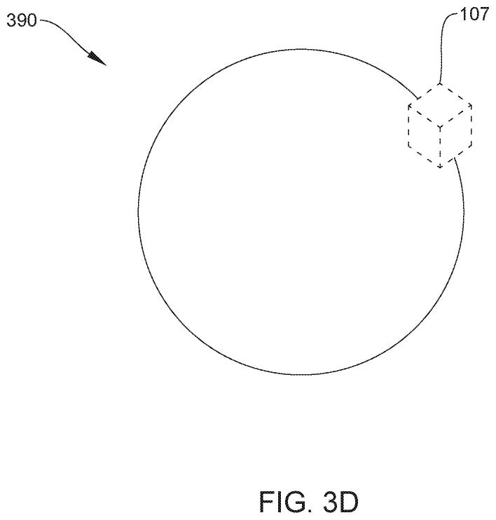

FIG. 3A shows an exemplary linear planar trajectory 300 of manipulating arms 201 (FIG. 2) used to generate the synthetic aperture radar image 219 (FIG. 2). In one exemplary embodiment, the linear planer trajectory 300 may have horizontal and vertical directions used to synthesize an aperture, enabling high horizontal and vertical resolution in the synthetic aperture image 219 (FIG. 2). In some embodiments, the horizontal direction may include a left to right geometric path 301 and a right to left geometric path 305. The horizontal direction may be aligned with the ground level. The vertical direction may include top to bottom geometric path 303. In some embodiments, the distance from the radar sensor(s) 111 to the container 107 may change as the manipulating arms 201 (FIG. 2) traverse the linear planar trajectory 300. In other embodiments, the distance from the radar sensor(s) 111 to the container 107 may stay constant as the manipulating arms 201 (FIG. 2) traverse the linear planar trajectory 300.

FIG. 3B shows an exemplary crossing trajectory 350 of manipulating arms 201 used to generate a synthetic radar aperture. In one exemplary embodiment, the crossing trajectory 350 may have a horizontal geometric path 351 that is used to synthesize an aperture in the horizontal direction, enabling high horizontal resolution in the synthetic aperture image 219 (FIG. 2). In some exemplary embodiments, the crossing trajectory 350 may include a vertical geometric path 358, used to synthesize an aperture in the vertical direction, enabling high vertical resolution in the synthetic aperture image 219 (FIG. 2). In one exemplary embodiment, the first movement of the forearm portion of one of the manipulating arms 201 (FIG. 2) according to the horizontal geometric path 351 and the second movement of the forearm portion of one of the manipulating arms 201 (FIG. 2) according to the vertical geometric path 358 may generate a synthetic radar aperture. In one exemplary embodiment, the radar sensor(s) 111 installed in the forearm portion of one of the manipulating arms 201 (FIG. 2) may generate a synthetic radar aperture by first moving the forearm portion according to the vertical geometric path 358 and second moving the forearm portion according to the horizontal geometric path 351. In some embodiments, manipulating arms 201 (FIG. 2) may grasp the non-transparent container 107 and move according to the horizontal and vertical geometric paths 351 and 358 to generate a synthetic radar aperture. In some embodiments, the distance from the radar sensor(s) 111 to the non-transparent container 107 may stay constant as the manipulating arms 201 (FIG. 2) traverse the crossing diagonal trajectory 350.

FIG. 3C shows an exemplary 3D trajectory 370 of manipulating arms 201 used to generate the synthetic aperture radar image 219 (FIG. 2). In one exemplary embodiment, the 3D trajectory 370 may have a three-dimensional geometric path 371 used to synthesize an aperture, enabling high horizontal and vertical resolution in the synthetic aperture image 219 (FIG. 2). In some embodiments, the manipulating arms 201 (FIG. 2) may grasp the non-transparent container 107 and move according to the three-dimensional geometric path 371 to generate a synthetic radar aperture. In one exemplary embodiment, the movement of the forearm portion of one of the manipulating arms 201 according to the three-dimensional geometric path 371 may generate a synthetic radar aperture.

FIG. 3D shows an exemplary circular trajectory 390 of manipulating arms 201 (FIG. 2) used in generating the synthetic aperture radar image 219 (FIG. 2). In one exemplary embodiment, the circular trajectory 390 may be used to generate a synthetic radar aperture, enabling both high horizontal and vertical resolution in the synthetic aperture image 219 (FIG. 2). In some embodiments, the manipulating arms 201 (FIG. 2) may grasp the non-transparent container 107 and move according to the circular trajectory 390 to generate a synthetic radar aperture. In one exemplary embodiment, the movement of the forearm portion of one of the manipulating arms 201 (FIG. 2) according to the circular trajectory 390 may generate a synthetic radar aperture.

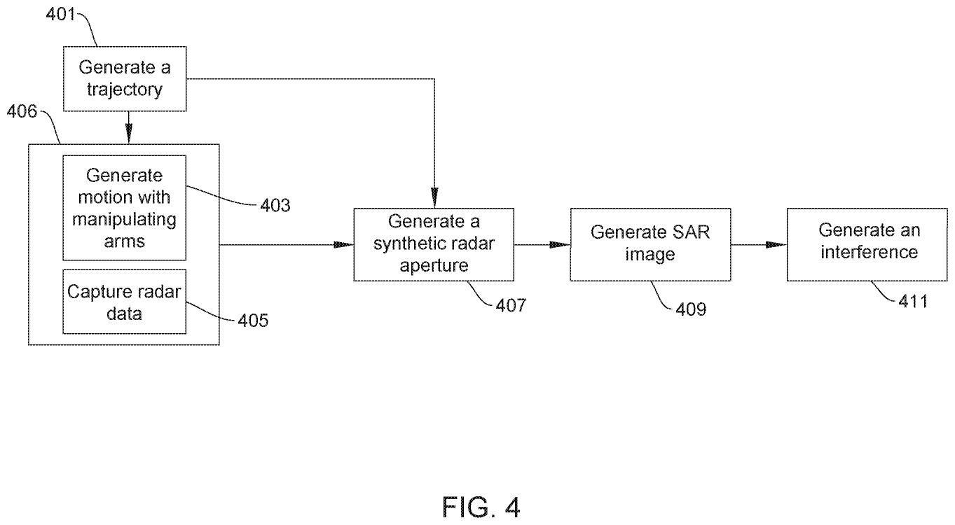

FIG. 4 is the flow diagram of a method for synthetic aperture radar imaging that utilizes the trajectory of manipulating arms of a humanoid robotic system for generating a synthetic radar aperture. The exemplary method shown in FIG. 4 can be performed by computing devices within the humanoid robotic system(s) 105 (FIG. 1A). In one embodiment, the method for synthetic aperture radar imaging of one or more items within a non-transparent container may begin with generating a trajectory (step 401), which may be used to generate the motion of the manipulating arms (step 403) through control action at the joints of the humanoid robotic system. As the manipulating arms move along the generated trajectory, the radar sensor(s) 111 (FIG. 1A) may capture radar data (step 405) of both the container and the manipulating arms. In some embodiments, the steps 403 and 405 are executed concurrently (step 406). In one embodiment, the synthetic radar aperture may be generated (step 407) based on the measured returned radar data. In some embodiments, the measured returned radar data includes time delays, phase shifts, and Doppler shifts, which are influenced by the relative motion of the radar sensor(s) 111 and the items within a non-transparent container 107 (FIG. 1A). In another embodiment, the synthetic radar aperture may be generated (step 407) based on the generated trajectory supplied from the step 401. In certain embodiments, the trajectory for generating a 3D synthetic aperture radar (SAR) image is generated using data from the motor encoders of the humanoid robotic system's 105 (FIG. 1A) joints and its manipulating arms 201 (FIG. 2). In certain embodiments, the forward kinematics of the humanoid robotic system(s) 105 (FIG. 1A) and its manipulating arms 201 (FIG. 2), combined with the joint encoder data, can be utilized to determine the trajectory needed for producing a 3D synthetic aperture radar (SAR) image. In certain embodiments, the trajectory may consist of a series of timestamped positions of the humanoid robotic system(s) 105, its manipulative arms 201, or the non-transparent container 107 (FIG. 1A). In one embodiment, a synthetic aperture radar (SAR) image may be generated (step 409) using the synthetic radar aperture. A signal processing unit, which may be installed within the radar sensor(s) 111 (FIG. 1A) may infer (step 411) the characteristics of the one or more items from the synthetic aperture radar image. In one embodiment, the signal processing unit may infer the characteristics of the one or more items by examining intensity variations within the synthetic aperture radar image that are linked to different materials. In other embodiments, the signal processing unit may infer the characteristics of the one or more items by examining shape variations within the synthetic aperture radar image that are linked to a common class of objects.

While various embodiments of the present disclosure have been described above, it should be understood that they have been presented by way of example only, and not by way of limitation. Likewise, the various diagrams may depict an example architectural or configuration, which are provided to enable persons of ordinary skill in the art to understand exemplary features and functions of the present disclosure. Such persons would understand, however, that the present disclosure is not restricted to the illustrated example architectures or configurations, but can be implemented using a variety of alternative architectures and configurations. Additionally, as would be understood by persons of ordinary skill in the art, one or more features of one embodiment can be combined with one or more features of another embodiment described herein. Thus, the breadth and scope of the present disclosure should not be limited by any of the above-described exemplary embodiments.

It is also understood that any reference to an element herein using a designation such as “first,” “second,” and so forth does not generally limit the quantity or order of those elements. Rather, these designations can be used herein as a convenient means of distinguishing between two or more elements or instances of an element. Thus, a reference to first and second elements does not mean that only two elements can be employed, or that the first element must precede the second element in some manner.

Additionally, a person having ordinary skill in the art would understand that information and signals can be represented using any of a variety of different technologies and techniques. For example, data, instructions, commands, information, signals, bits and symbols, for example, which may be referenced in the above description can be represented by voltages, currents, electromagnetic waves, magnetic fields or particles, optical fields or particles, or any combination thereof.

A person of ordinary skill in the art would further appreciate that any of the various illustrative logical blocks, modules, processors, means, circuits, methods and functions described in connection with the aspects disclosed herein can be implemented by electronic hardware (e.g., a digital implementation, an analog implementation, or a combination of the two), firmware, various forms of program or design code incorporating instructions (which can be referred to herein, for convenience, as “software” or a “software module), or any combination of these techniques.

To clearly illustrate this interchangeability of hardware, firmware and software, various illustrative components, blocks, modules, circuits, and steps have been described above generally in terms of their functionality. Whether such functionality is implemented as hardware, firmware or software, or a combination of these techniques, depends upon the particular application and design constraints imposed on the overall system. Skilled artisans can implement the described functionality in various ways for each particular application, but such implementation decisions do not cause a departure from the scope of the present disclosure. In accordance with various embodiments, a processor, computing device, component, circuit, structure, machine, module, etc. can be configured to perform one or more of the functions described herein. The term “configured to” or “configured for” as used herein with respect to a specified operation or function refers to a processor, computing device, component, circuit, structure, machine, module, etc. that is physically constructed, programmed, instructed and/or arranged to perform the specified operation or function.

Furthermore, a person of ordinary skill in the art would understand that various illustrative logical blocks, modules, computing devices, components and circuits described herein can be implemented within or performed by an integrated circuit (IC) that can include a general purpose processor, a digital signal processor (DSP), an application specific integrated circuit (ASIC), a field programmable gate array (FPGA) or other programmable logic device, or any combination thereof. The logical blocks, modules, and circuits can further include antennas and/or transceivers to communicate with various components within the network or within the device. A general purpose processor can be a microprocessor, but in the alternative, the processor can be any conventional processor, controller, or state machine. A processor can also be implemented as a combination of computing devices, e.g., a combination of a DSP and a microprocessor, a plurality of microprocessors, one or more microprocessors in conjunction with a DSP core, or any other suitable configuration to perform the functions described herein.

If implemented in software, the functions can be stored as one or more instructions or code on a computer-readable medium. Thus, the steps of a method or algorithm disclosed herein can be implemented as software stored on a computer-readable medium. Computer-readable media includes both computer storage media and communication media including any medium that can be enabled to transfer a computer program or code from one place to another. A storage media can be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to store desired program code in the form of instructions or data structures and that can be accessed by a computer.

In this document, the term “module” as used herein, refers to software, firmware, hardware, and any combination of these elements for performing the associated functions described herein. Additionally, for purpose of discussion, the various modules are described as discrete modules; however, as would be apparent to one of ordinary skill in the art, two or more modules may be combined to form a single module that performs the associated functions according embodiments of the present disclosure.

Additionally, memory or other storage, as well as communication components, may be employed in embodiments of the present disclosure. It will be appreciated that, for clarity purposes, the above description has described embodiments of the present disclosure with reference to different functional units and processors. However, it will be apparent that any suitable distribution of functionality between different functional units, processing logic elements or domains may be used without detracting from the present disclosure. For example, functionality illustrated to be performed by separate processing logic elements, or controllers, may be performed by the same processing logic element, or controller. Hence, references to specific functional units are only references to a suitable means for providing the described functionality, rather than indicative of a strict logical or physical structure or organization.

Various modifications to the implementations described in this disclosure will be readily apparent to those skilled in the art, and the general principles defined herein can be applied to other implementations without departing from the scope of this disclosure. Thus, the disclosure is not intended to be limited to the implementations shown herein, but is to be accorded the widest scope consistent with the novel features and principles disclosed herein, as recited in the claims below.

What is claimed is:

1. A method of inferring characteristics of one or more objects, comprising:
generating a trajectory at a humanoid robotic system equipped with a radar sensor;
moving manipulating arms of the humanoid robotic system according to the generated trajectory;
generating, a synthetic radar aperture from the movement of the manipulating arms;
generating, by the radar sensor, a synthetic aperture radar image; and
inferring the characteristics of the one or more objects from the synthetic aperture radar image.

2. The method of claim 1, further comprising grasping the one or more objects with the manipulating arms of the humanoid robotic system, and generating inverse synthetic radar aperture, wherein the radar sensor is installed in at least one of head or torso portion of the humanoid robotic system.

3. The method of claim 1, wherein the one or more objects are inside a non-transparent container.

4. The method of claim 3, further comprising classifying into a category the one or more objects within the non-transparent container based on the inferred characteristics.

5. The method of claim 1, wherein the radar sensor is installed in a forearm portion of the manipulating arms of the humanoid robotic system, wherein the synthetic radar aperture is generated by the movement of the forearm portion.

6. The method of claim 1, wherein the trajectory is dynamically generated based on at least one of spatial dimensions of the one or more objects and a resolution of the synthetic aperture radar image required for inferring the characteristics of the one or more objects.

7. The method of claim 1, wherein the trajectory comprises horizontal and vertical directions, where the horizontal direction has a right to left geometric path and left to right geometric path.

8. The method of claim 3, wherein a distance from the radar sensor to the non-transparent container is constant as the manipulating arms of the humanoid robotic system move according to the generated trajectory.

9. The method of claim 1, wherein the generation of the synthetic radar aperture is based on radar sensor data measuring the movement of the manipulating arms.

10. The method of claim 1, wherein the generation of the synthetic radar aperture is based on data from onboard sensors located on the humanoid robotic system measuring the movement of the manipulating arms.

11. The method of claim 4, further comprising determining a subsequent action for the non-transparent container by the humanoid robotic system, wherein the subsequent action is selected based on the category of the one or more objects within the non-transparent container.

12. A humanoid robotic system comprising:
manipulating arms configured to grasp a non-transparent container;
a computing device configured to generate a trajectory;
a radar sensor configured to generate a synthetic aperture radar image of one or more objects within the non-transparent container based on a synthetic radar aperture obtained from a movement of the manipulating arms that tracks the generated trajectory; and
a signal processing unit configured to infer characteristics of the one or more objects from the synthetic aperture radar image.

13. The humanoid robotic system of claim 12, wherein the radar sensor is installed in at least one of head or torso portion of the humanoid robotic system.

14. The humanoid robotic system of claim 12, wherein the trajectory comprises a crossing horizontal geometric path and a vertical geometric path.

15. The humanoid robotic system of claim 12, wherein the computing device dynamically generates the trajectory based on at least one of spatial dimensions of the one or more objects and a resolution of the synthetic aperture radar image required for inferring the characteristics of the one or more objects.

16. The humanoid robotic system of claim 12, further configured to classify into a category the one or more objects within the non-transparent container based on the inferred characteristics and to transport the non-transparent container to an inventory storage area designated for the category.

17. A distribution facility comprising:
a conveyance area configured to receive one or more non-transparent containers stacked on a transport platform;
a humanoid robotic system comprising:
manipulating arms configured to grasp a particular non-transparent container,
a computing device configured to generate a trajectory,
a radar sensor configured to generate a synthetic aperture radar image of one or more objects within the particular non-transparent container based on a synthetic radar aperture obtained from a movement of the manipulating arms that tracks the generated trajectory, and
a signal processing unit configured to infer characteristics of the one or more objects from the synthetic aperture radar image; and
an inventory storage area having a rack corresponding to a category and configured to receive the one or more non-transparent containers.

18. The distribution facility of claim 17, wherein the humanoid robotic system transports the one or more non-transparent containers to the rack corresponding to the category into which the one or more objects are classified into.

19. The distribution facility of claim 17, wherein the trajectory comprises linear geometric paths.

20. The distribution facility of claim 17, wherein the category corresponds to at least one of fragile, sturdy, complete, missing, safe, and unsafe.
